(19) United States
(12) Patent Application Publication
(10) Pub. No.: US 2011/0115920 A1
(43) Pub. Date: May 19, 2011

(54) MULTI-STATE TARGET TRACKING MEHTOD AND SYSTEM

(75) Inventors: Jian-Cheng Wang, Hsinchu County (TW); Cheng-Chang Lien, Hsinchu County (TW); Ya-Lin Huang, Hualien County (TW); Yue-Min Jiang, Hsinchu City (TW)

(73) Assignee: INDUSTRIAL TECHNOLOGY RESEARCH INSTITUTE, Hsinchu (TW)

(21) Appl. No.: 12/703,207

(22) Filed: Feb. 10, 2010

(30) Foreign Application Priority Data
Nov. 18, 2009 (TW) 98139197

(51) Int. Cl. G06K 9/00; H04N 5/225

(52) U.S. Cl. 348/169; 382/103; 348/E05.024

(57) ABSTRACT

A multi-state target tracking method and a multi-state target tracking system are provided. The method detects a crowd density of a plurality of images in a video stream and compares the detected crowd density with a threshold when receiving the video stream, so as to determine a tracking mode used for detecting the targets in the images. When the detected crowd density is less than the threshold, a background model is used to track the targets in the images. When the detected crowd density is greater than or equal to the threshold, a none-background model is used to track the targets in the images.

### CROSS-REFERENCE TO RELATED APPLICATION

This application claims the priority benefit of Taiwan application serial no. 98139197, filed Nov. 18, 2009. The entirety of the above-mentioned patent application is hereby incorporated by reference herein and made a part of specification.

### BACKGROUND

1. Field

The disclosure relates to a multi-state target tracking method.

2. Description of Related Art

In recent years, as issues of environmental safety become increasingly important, research of a video surveillance technique becomes more important. Besides a conventional video recording surveillance, demands for smart event detection and behaviour recognition are accordingly increased. To grasp occurrence of events at a first moment and immediately take corresponding measures are functions that a smart video surveillance system must have. To achieve a correct event detection and behaviour recognition, besides an accurate target segmentation is required, a stable tacking is also required, so as to completely describe an event process, record target information and analyse its behaviour.

Actually, in a low crowd density environment, as long as the target segmentation is accurate, a general tracking technique has a certain degree of accuracy, for example, a general foreground detection using a background model in cooperation with a shift amount prediction and characteristics comparison. However, in a high crowd density environment, an effect of the foreground detection is unsatisfactory, so that the prediction and capture of characteristics are difficult, and a tracking accuracy is comparatively low. Therefore, another non-background model tacking technique has to be used to solve such problem. However, since it is lack of characteristic information (such as color, length and width, area, etc.) provided by the background model, a plenty of targets is required to provide the characteristics required by the tracking. Comparatively, in case of the low crowd density environment, the tracking is not necessarily better than that with establishment of the background model. Therefore, a tracking mode switch mechanism adapted to an actual surveillance environment is required.

### SUMMARY

The disclosure is directed to a multi-state target tacking method, by which a most suitable tracking mode can be determined by analysing a crowd density and used for tracking targets.

The disclosure is directed to a multi-state target tacking system, which can continually detects a variation of a crowd density, so as to suitably switch a tracking mode for tracking targets.

The disclosure provides a multi-state target tracking method. In the method, when a video stream of a plurality of images is captured, a crowd density of the images is detected and is compared with a threshold, so as to determine a tracking mode used for detecting a plurality of targets in the images. When the detected crowd density is less than the threshold, a background model is used to track the targets in the images. When the detected crowd density is greater than or equal to the threshold, a non-background model is used to track the targets in the images.

The disclosure provides a multi-state target tracking system including an image capturing device, and a processing device. The image capturing device is used for capturing a video stream of a plurality of images. The processing device is coupled to the image capturing device, and is used for tracking a plurality of targets in the images, which includes a crowd density detecting module, a comparison module, a background tracking module and a non-background tracking module. The crowd density detecting module is used for detecting a crowd density of the images. The comparison module is used for comparing the crowd density detected by the crowd density detecting module with a threshold, so as to determine a tracking mode used for tracking the targets in the images. The background tracking module uses a background model to track the targets in the images when the comparison module determines that the crowd density is less than the threshold. The non-background tracking module uses a non-background model to track the targets in the images when the comparison module determines that the crowd density is greater than or equal to the threshold.

According to the above descriptions, in the multi-state target tracking method and system of the disclosure, by detecting the crowd density of the images in the video stream, the background model or the non-background model can be automatically selected to track the targets, and the tracking mode can be adjusted according to an actual environment variation, so as to achieve a purpose of effectively and correctly tracking the targets.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a multi-state target tracking system according to a first exemplary embodiment of the disclosure.

FIG. 2 is a flowchart illustrating a multi-state target tracking method according to a first exemplary embodiment of the disclosure.

FIG. 3 is a flowchart illustrating a background tracking method according to a first exemplary embodiment of the disclosure.

FIG. 4 is a flowchart illustrating a non-background tracking method according to a first exemplary embodiment of the disclosure.

FIG. 5(a) and FIG. 5(b) are examples of a multi-state target tracking method according to a first exemplary embodiment of the disclosure.

FIG. 6 is a flowchart illustrating a multi-state target tracking method according to a second exemplary embodiment of the disclosure.

FIG. 7 is an example of a multi-state target tracking method according to a second exemplary embodiment of the disclosure.

FIG. 8 is a flowchart illustrating a multi-state target tracking method according to a third exemplary embodiment of the disclosure.

### DESCRIPTION OF THE EMBODIMENTS

The disclosure provides an integral and practical multi-state target tracking mechanism, which is adapted to actually surveille an environmental crowd density. By correctly determining the crowd density, selecting a suitable tracking mode, switching the tracking mode and transmitting data during the switching, the tracking can be effectively and correctly performed in any environment.

### First Exemplary Embodiment

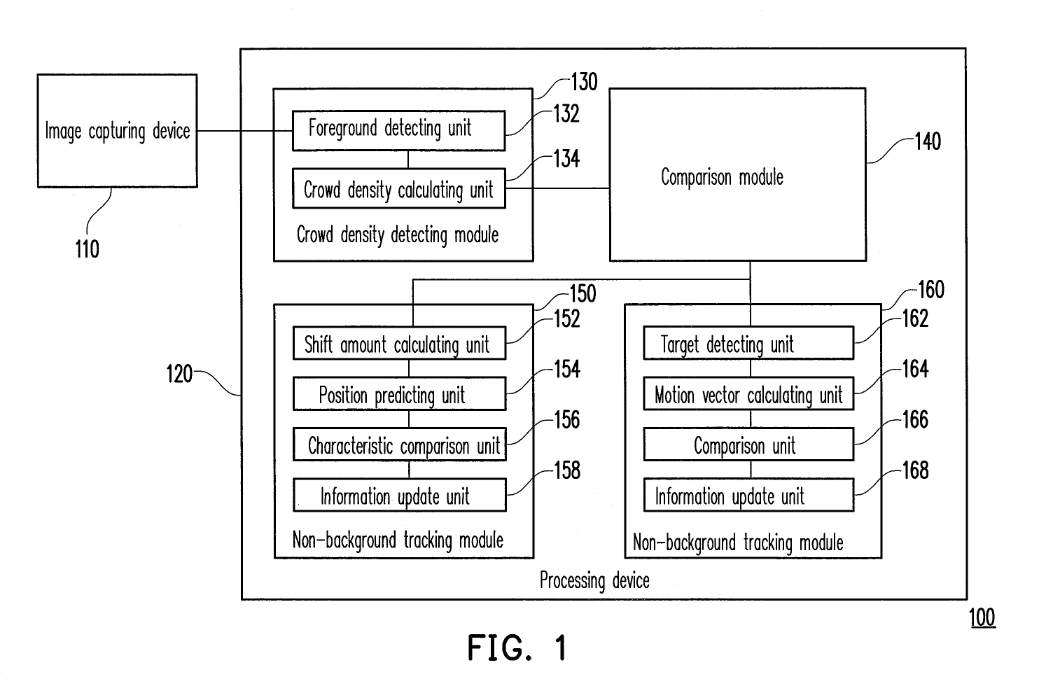

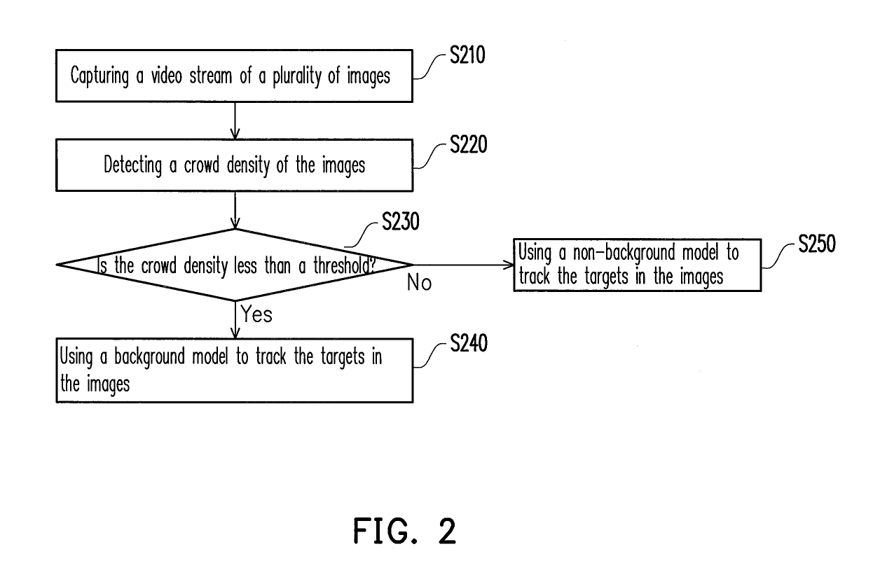

FIG. 1 is a block diagram illustrating a multi-state target tracking system according to the first exemplary embodiment of the disclosure. FIG. 2 is a flowchart illustrating a multi-state target tracking method according to the first exemplary embodiment of the disclosure. Referring to FIG. 1 and FIG. 2, the multi-state target tracking system 100 of the present embodiment includes an image capturing device 110 and a processing device 120. The processing device 120 is coupled to the image capturing device 110, and includes a crowd density detecting module 130, a comparison module 140, a background tracking module 150 and a non-background tracking module 160. The multi-state target tracking method of the present embodiment is described in detail below with reference to various components of the multi-state target tracking system 100.

First, the image capturing device 110 captures a video stream of a plurality of images (step S210), wherein the image capturing device 110 is a surveillance equipment such as a closed circuit television (CCTV) or an IP camera, which is used for capturing images of a specific region for surveillance. After the video stream is captured by the image capturing device 110, the video stream is transmitted to the processing device 120 through a wired or a wireless approach for post processing.

After the processing device 120 receives the video stream, the crowd density detecting module 130 detects a crowd density of the images (step S220). In detail, the crowd density detecting module 130 can use a foreground detecting unit 132 to perform a foreground detection on the images, so as to detect targets in the images. The foreground detecting unit 132, for example, uses an image processing method, such as a general background subtraction method, an edge detection method or a corner detection method, to detect variation amounts of the images at different time points, so as to recognize the targets in the images. Then, the crowd density detecting module 130 uses a crowd density calculating unit 134 to calculate a proportion of the targets in the images, so as to obtain the crowd density of the images.

Next, the processing device 120 uses the comparison module 140 to compare the crowd density detected by the crowd density detecting module 130 with a threshold, so as to determine a tracking mode used for tracking the targets in the images (step S230). The tracking mode includes a background model suitable for a pure environment, and a non-background model suitable for a complex environment.

When the comparison module 140 determines that the crowd density is less than the threshold, the background tracking module 150 uses the background model to track the targets in the images (step S240). Wherein, the background tracking module 150 calculates a shift amount of the target at tandem time points, predicts a position of the target appeared at a next time point, and performs a regional characteristic comparison on a region around the predicted position, so as to obtain moving information of the target.

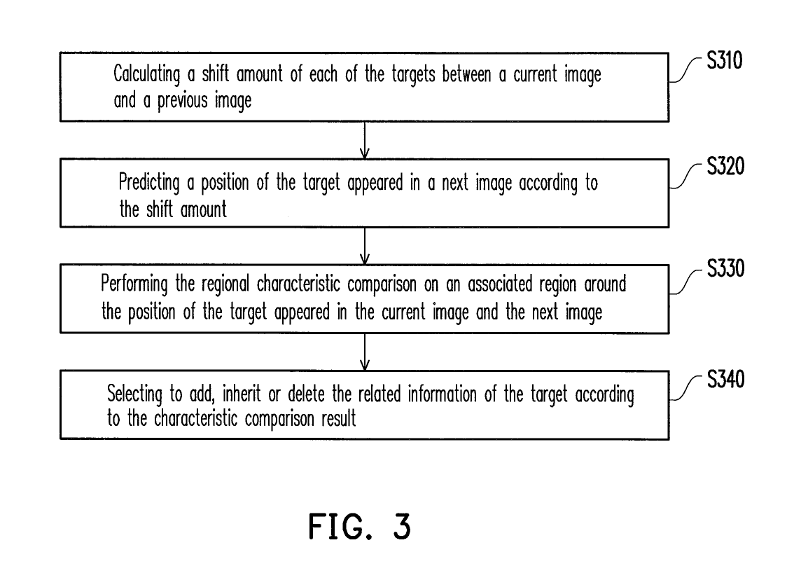

In detail, FIG. 3 is a flowchart illustrating a background tracking method according to the first exemplary embodiment of the disclosure. Referring to FIG. 1 and FIG. 3, the background tracking method of the background tracking module 150 of FIG. 1 is described in detail below. The background tracking module 150 includes a shift amount calculating unit 152, a position predicting unit 154, a characteristic comparison unit 156 and an information update unit 158, wherein functions thereof are respectively described below.

First, the shift amount calculating unit 152 calculates a shift amount of each of the targets between a current image and a previous image (step S310). Next, the position predicting unit 154 predicts a position of the target appeared in a next image according to the shift amount calculated by the shift amount calculating unit 152 (step S320). After the predicted position of the target is obtained, the characteristic comparison unit 156 performs the regional characteristic comparison on an associated region around the position of the target appeared in the current image and the next image, so as to obtain a characteristic comparison result (step S330). Finally, the information update unit 158 selects to add, inherit or delete the related information of the target according to the characteristic comparison result obtained by the characteristic comparison unit 156 (step S340).

In step S230 of FIG. 2, when the comparison module 140 determines that the crowd density is greater than or equal to the threshold, the non-background tracking module 160 uses the non-background model to track the targets in the images (step S250). Wherein, the non-background tracking module 160 performs motion vector analysis on a plurality of characteristic points in the images, so as to compare the motion vectors to obtain the moving information of the targets.

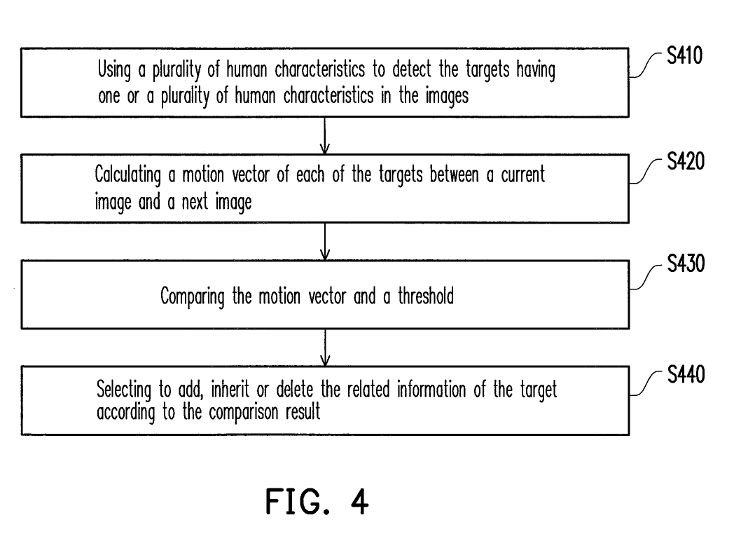

In detail, FIG. 4 is a flowchart illustrating a non-background tracking method according to the first exemplary embodiment of the disclosure. Referring to FIG. 1 and FIG. 4, the non-background tracking method of the non-background tracking module 160 of FIG. 1 is described in detail below. The non-background tracking module 160 includes a target detecting unit 162, a motion vector calculating unit 164, a comparison unit 166 and an information update unit 168, wherein functions thereof are respectively described below.

First, the target detecting unit 162 uses a plurality of human characteristics to detect the targets having one or a plurality of the human characteristics in the images (step S410). The human characteristics refer to facial characteristics, such as eyes, nose and mouth of a human face, or body characteristics of a human body, which can be used to recognize a person in the image. Next, the motion vector calculating unit 164 calculates a motion vector of each of the targets between a current image and a previous image (step S420). The comparison unit 166 compares the motion vector calculated by the motion vector calculating unit 164 with a threshold to obtain a comparison result (step S430). Finally, the information update unit 168 selects to add, inherit or delete the related information of the target according to the comparison result obtained by the comparison unit 166 (step S440).

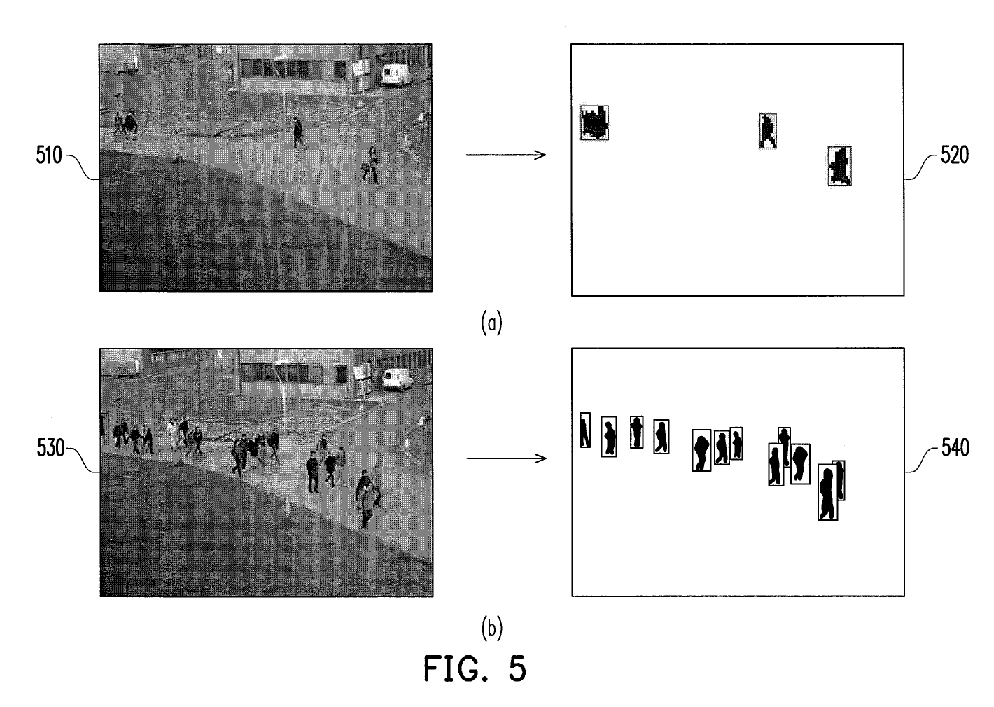

For example, FIG. 5(a) and FIG. 5(b) are examples of the multi-state target tracking method according to the first exemplary embodiment of the disclosure. Referring to FIG. 5(a), a crowd density of an image 510 is detected and is compared with the threshold, so as to determine that a target state of the image 510 belongs to a low crowd density. Therefore, the background model is used to track the targets in the image 510, so as to obtain a better tracking result 520. Referring to FIG. 5(b), a crowd density of an image 530 is detected and is compared with the threshold, so as to determine that a target state of the image 530 belongs to a high crowd density. Therefore, the non-background model is used to track the targets in the image 530, so as to obtain a better tracking result 540.

In summary, in the present embodiment, a most suitable tracking mode is selected according to a magnitude of the crowd density, so as to track the targets in the images. The method of the present embodiment is adapted to various environments and can provide a better tracking result. It should be noticed that in the present embodiment, using the background model or the non-background model to track the targets is performed in allusion to a whole image. However, in another embodiment, the image can be divided into a plurality of regions according to a distribution status of the targets, and a suitable tracking mode of each region can be selected to track the targets, so as to obtain a better tracking effect. An embodiment is provided below for detailed description.

### Second Exemplary Embodiment

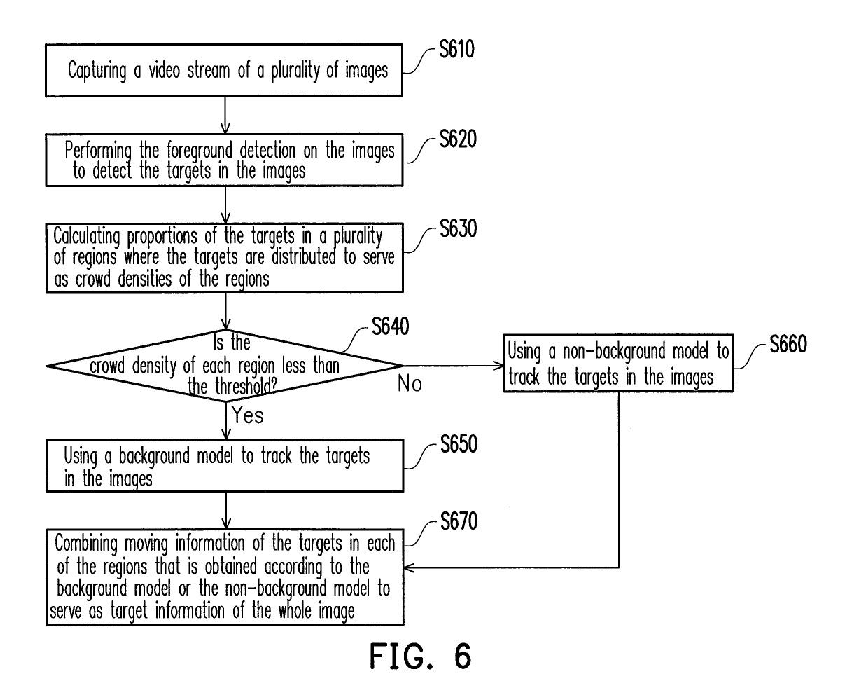

FIG. 6 is a flowchart illustrating a multi-state target tracking method according to the second exemplary embodiment of the disclosure. Referring to FIG. 1 and FIG. 6, the multi-state target tracking method is adapted to the multi-state target tracking system 100 of FIG. 1, and the tracking method of the present embodiment is described in detail below with reference to various components of the multi-state target tracking system 100.

First, the image capturing device 110 captures a video stream of a plurality of images (step S610), and the captured video stream is transmitted to the processing device 120 through a wired or a wireless approach.

Next, the processing device 120 uses the crowd density detecting module 130 to detect a crowd density of the images in the video stream. Wherein, the crowd density detecting module 130 also uses the foreground detecting unit 132 to perform a foreground detection on the images, so as to detect the targets in the images (step S620). However, a difference between the present embodiment and the aforementioned embodiment is that when calculating the crowd density, the crowd density calculating unit 134 respectively calculates the crowd density of a plurality of regions corresponding to a target distribution in the images, and regards a proportion of the targets in each of the regions as a crowd density of such region (step S630).

Comparatively, when the processing device 120 selects the tracking mode, the processing device 120 uses the comparison module 140 to compare the crowd density of each region with the threshold, so as to determine the tracking modes used for detecting the targets in the regions (step S640). The tracking mode includes the background model suitable for a pure environment, and the non-background model suitable for a complex environment.

When the comparison module 140 determines that the crowd density of a region is less than the threshold, the background tracking module 150 uses the background model to track the targets in such region (step S650). Wherein, the background tracking module 150 calculates a shift amount of the target in the region at tandem time points, predicts a position of the target appeared at a next time point, and performs a regional characteristic comparison to obtain the moving information of the target.

When the comparison module 140 determines that the crowd density of the region is greater than or equal to the threshold, the non-background tracking module 160 uses the non-background model to track the targets in such region (step S660). Wherein, the non-background tracking module 160 performs motion vector analysis on a plurality of characteristic points in the region, so as to compare the motion vectors to obtain the moving information of the targets in such region.

It should be noticed that after the target information of each region is obtained, a target information combination module (not shown) is further used to combine the moving information of the targets in the regions of the image that are obtained by the background tracking module 150 and the non-background tracking module 160, so as to obtain target information of the whole image (step S670).

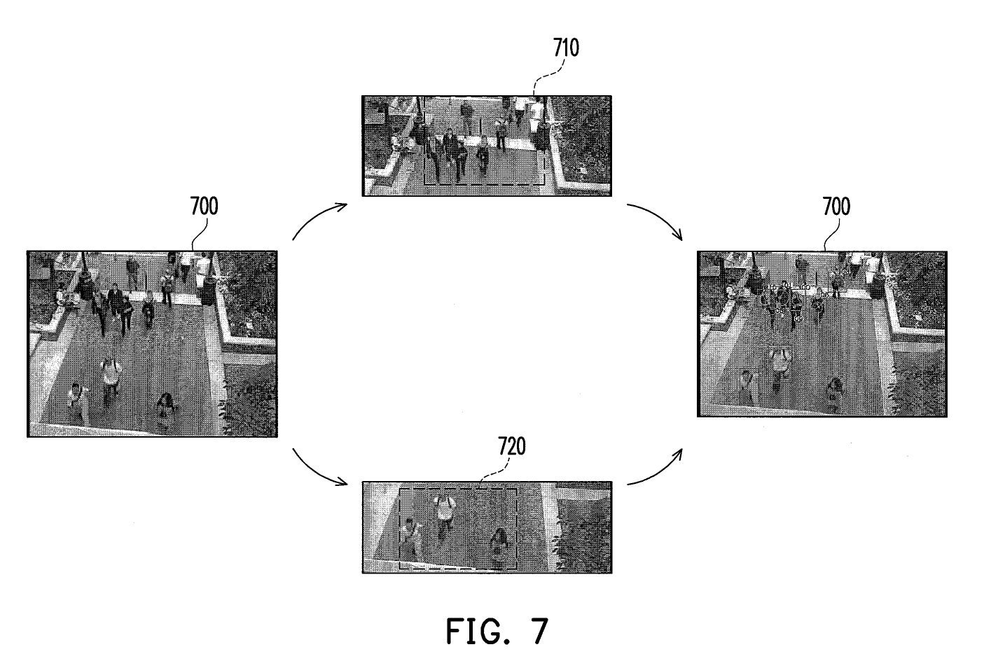

For example, FIG. 7 is an example of the multi-state target tracking method according to the second exemplary embodiment of the disclosure. Referring to FIG. 7, targets in an image 700 are tracked, and the image 700 can be divided into regions 710 and 720 according to the foreground detection and the crowd density detection. By respectively comparing the crowd densities of the regions 710 and 720 with the threshold, the states of the regions 710 and 720 can be determined, so that the suitable tracking mode can be selected to track the targets. Wherein, the region 720 is determined to have a low crowd density, so that the background model is selected to track the targets in the region 720. Meanwhile, the region 710 is determined to have a high crowd density, so that the non-background model is selected to track the targets in the region 710. Finally, the moving information of the targets in the regions 720 and 710 that are obtained according to the background model and the non-background model are combined, so as to obtain the target information of the whole image 700.

In summary, in the multi-state target tracking system 100 of the present embodiment, the image can be divided into a plurality of region according to the distribution status of the detected targets for calculating the crowd densities and selecting the tracking modes, so as to provide an optimal tracking result.

It should be noticed that after the above multi-state target tracking method is used to obtain the target information, variation of the crowd density is continually detected, so as to suitably switch the tracking modes to achieve a better tracking effect. Another embodiment is provided below for further description.

### Third Exemplary Embodiment

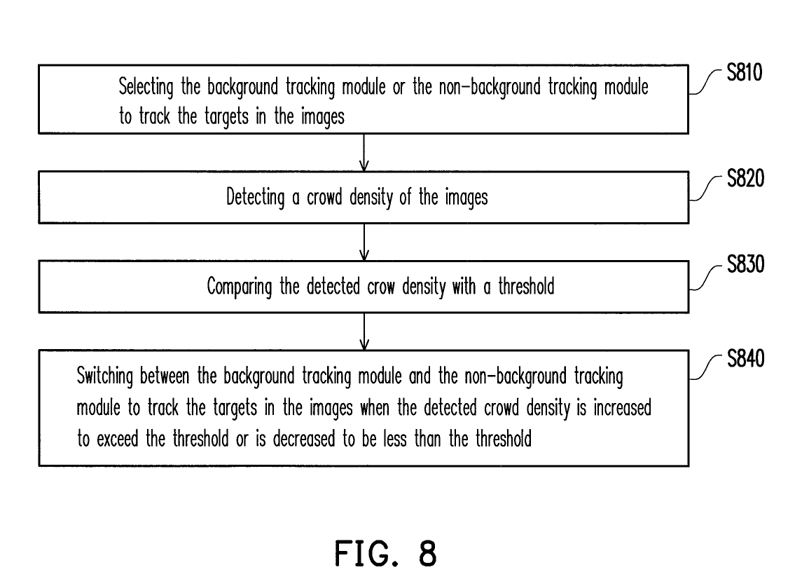

FIG. 8 is a flowchart illustrating a multi-state target tracking method according to the third exemplary embodiment of the disclosure. Referring to FIG. 1 and FIG. 8, the multi-state target tracking method is adapted to the multi-state target tracking system 100 of FIG. 1, and the multi-state target tracking method of the present embodiment is described in detail below with reference to various components of the multi-state target tracking system 100.

First, the processing device 120 selects the background tracking module 150 or the non-background tracking module 160 to track the targets in the images according to a comparison result of the comparison module 140 (step S810).

While the targets are tracked, the processing device 120 continually uses the crowd density detecting module 130 to detect the crowd density of the images (step S820), and uses the comparison module 140 to compare the crowd density detected by the crowd density detecting module 130 with the threshold (step S830).

Wherein, when the comparison module 140 determines that the crowd density detected by the crowd density detecting module 130 is increased to exceed the threshold, the tracking mode of the targets is changed from the background model (used by the background tracking module 150 to perform the background tracking) to the non-background model (used by the non-background tracking module 160 to perform the non-background tracking). Similarly, when the comparison module 140 determines that the crowd density detected by the crowd density detecting module 130 is decreased to be less than the threshold, the tracking mode of the targets is changed from the non-background model (used by the non-background tracking module 160 to perform the non-background tracking) to the background model (used by the background tracking module 150 to perform the background tracking) (step S840).

It should be noticed that the approach for continually detecting the crowd density and updating the tracking mode of the present embodiment can also be applied to the second exemplary embodiment (in which the image is divided into a plurality of the regions to respectively perform the crowd density calculation, the tracking mode determination and the targets tracking), as long as the crowd density in the region is increased or decreased to cross the threshold, the tracking modes can be adaptively switched to achieve a better tracking effect.

In summary, in the multi-state target tracking method and system of the disclosure, based on a series of automatic detection and switching steps, such as the crowd density detection, switching of the tracking modes, inheriting of the tracking data, the most suitable tracking mode can be selected, and the targets can be continually and stably tracked in case of different environment.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A multi-state target tracking method, comprising:
capturing a video stream comprising a plurality of images;
detecting a crowd density of the images in the video stream, and comparing the crowd density with a threshold, so as to determine a tracking mode used for detecting a plurality of targets in the images;
using a background model to track the targets in the images when the detected crowd density is less than the threshold; and
using a non-background model to track the targets in the images when the detected crowd density is greater than or equal to the threshold.

2. The multi-state target tracking method as claimed in claim 1, wherein the step of detecting the crowd density of the images comprises:
performing a foreground detection on the images to detect the targets in the images; and
calculating proportions of the targets in a plurality of regions where the targets are distributed to serve as crowd densities of the regions.

3. The multi-state target tracking method as claimed in claim 2, wherein the step of performing the foreground detection on the images to detect the targets in the images comprises:
using one of a background subtraction method, an edge detection method, a corner detection method, or combinations thereof to detect the targets in the images.

4. The multi-state target tracking method as claimed in claim 2, wherein the step of determining the tracking mode used for detecting the targets in the images comprises:
selecting the background model or the non-background model to track the targets in the region according to the crowd density of each of the regions.

5. The multi-state target tracking method as claimed in claim 4, wherein after the step of selecting the background model or the non-background model to track the targets in the region according to the crowd density of each of the regions, the method further comprises:
combining moving information of the targets in each of the regions that is obtained according to the background model or the non-background model to serve as target information of the image.

6. The multi-state target tracking method as claimed in claim 1, wherein the step of using the background model to track the targets in the images comprises:
calculating a shift amount of each of the targets between a current image and a previous image;
predicting a position of the target appeared in a next image according to the shift amount, and
performing a regional characteristic comparison on an associated region around the position of the target appeared in the current image and the next image, so as to obtain a characteristic comparison result; and
selecting to add, inherit or delete related information of the target according to the characteristic comparison result.

7. The multi-state target tracking method as claimed in claim 1, wherein the step of using the non-background model to track the targets in the images comprises:
using a plurality of human characteristics to detect the targets having one or a plurality of the human characteristics in the images;
calculating a motion vector of each of the targets between a current image and a next image;
comparing the motion vector with a threshold to obtain a comparison result; and
selecting to add, inherit or delete related information of the target according to the comparison result.

8. The multi-state target tracking method as claimed in claim 1, wherein after the step of using the background model or the non-background model to track the targets in the images, the method further comprises:
continually detecting the crowd density of the images, and comparing the crowd density with the threshold; and
switching the tracking mode to track the targets in the images when the crowd density is increased to exceed the threshold or is decreased to be less than the threshold.

9. A multi-state target tracking system, comprising:
an image capturing device, for capturing a video stream of a plurality of images; and
a processing device, coupled to the image capturing device, for tracking a plurality of targets in the images, and comprising:
a crowd density detecting module, for detecting a crowd density of the images;
a comparison module, for comparing the crowd density detected by the crowd density detecting module with a threshold, so as to determine a tracking mode used for tracking the targets in the images;
a background tracking module, for using a background model to track the targets in the images when the comparison module determines that the crowd density is less than the threshold; and
a non-background tracking module, for using a non-background model to track the targets in the images when the comparison module determines that the crowd density is greater than or equal to the threshold.

10. The multi-state target tracking system as claimed in claim 9, wherein the crowd density detecting module comprises:
a foreground detecting unit, for performing a foreground detection on the images to detect the targets in the images; and
a crowd density calculating unit, for calculating proportions of the targets in a plurality of regions where the targets are distributed to serve as crowd densities of the regions.

11. The multi-state target tracking system as claimed in claim 10, wherein the foreground detecting unit uses one of a background subtraction method, an edge detection method, a corner detection method, or combinations thereof to detect the targets in the images.

12. The multi-state target tracking system as claimed in claim 10, wherein the comparison module further selects the background model or the non-background model to track the targets in the region according to the crowd density of each of the regions detected by the crowd density detecting module.

13. The multi-state target tracking system as claimed in claim 10, wherein the processing device further comprises:
a target information combination module, connected to the background tracking module and the non-background tracking module, for combining moving information of the targets in each of the regions that is obtained according to the background model or the non-background model to serve as target information of the image.

14. The multi-state target tracking system as claimed in claim 9, wherein the background tracking module comprises:
a shift amount calculating unit, for calculating a shift amount of each of the targets between a current image and a previous image;
a position predicting unit, connected to the shift amount calculating unit, for predicting a position of the target appeared in a next image according to the shift amount, and
a characteristic comparison unit, connected to the position predicting unit, for performing a regional characteristic comparison on an associated region around the position of the target appeared in the current image and the next image, so as to obtain a characteristic comparison result; and
an information update unit, connected to the characteristic comparison unit, for selecting to add, inherit or delete related information of the target according to the characteristic comparison result.

15. The multi-state target tracking system as claimed in claim 9, wherein the non-background tracking module comprises:
a target detecting unit, for using a plurality of human characteristics to detect the targets having one or a plurality of the human characteristics in the images;
a motion vector calculating unit, for calculating a motion vector of each of the targets between a current image and a next image;
a comparison unit, for comparing the motion vector calculated by the motion vector calculating unit with a threshold to obtain a comparison result; and
an information update unit, connected to the comparison unit, for selecting to add, inherit or delete related information of the target according to the comparison result.

16. The multi-state target tracking system as claimed in claim 9, wherein the comparison module switches between the background tracking module and the non-background tracking module to track the targets in the images when the crowd density detected by the crowd density detecting module is increased to exceed the threshold or is decreased to be less than the threshold.
